(19) United States
(12) Patent Application Publication
(10) Pub. No.: US 2022/0413149 A1
(43) Pub. Date: Dec. 29, 2022

(54) OPERATING METHOD AND CONTROL UNIT FOR A LIDAR SYSTEM, LIDAR SYSTEM, AND DEVICE

(71) Applicant: Robert Bosch GmbH, Stuttgart (DE)

(72) Inventors: Norman Haag, Stuttgart (DE); Stefan Spiessberger, Weinstadt (DE)

(21) Appl. No.: 17/772,637

(22) PCT Filed: Nov. 4, 2020
(86) PCT No.: PCT/EP2020/080932

§ 371 Date: Apr. 28, 2022

(30) Foreign Application Priority Data
Nov. 7, 2019 (DE) 10 2019 217 165.6

(51) Int. Cl. G01S 17/89; G01S 7/481

(52) U.S. Cl. CPC G01S 17/89; G01S 7/4814; G01S 7/4817

(57) ABSTRACT

An operating method for a LIDAR system, in particular of the compressed sensing type. In the method, on the emitter side and in particular in an emitter unit, by light structuring of primary light, a predefined fixed and temporally constant matrix-like primary light pattern is generated from predefined and temporally constant primary column patterns and emitted as structured primary light in a line direction of the underlying matrix by pivoting in a field of view for its scanning illumination. On the receiver side and in particular in a receiver unit, a particular received column pattern, for detection, is, on an assigned shared detector element of a detector arrangement, received, mapped, and detected in total as secondary light.

### FIELD

The present invention relates to an operating method and a control unit for a LIDAR system, a LIDAR system as such, and a working device which is designed including a LIDAR system and in particular as a vehicle.

### BACKGROUND INFORMATION

Increasingly, so-called LIDAR systems (LIDAR: Light Detection and Ranging) are used for surroundings detection of working devices and in particular of vehicles, which are designed to apply light or infrared radiation to a field of view and to detect and evaluate radiation reflected from the field of view to analyze the field of view and detect objects contained therein. To improve LIDAR systems and methods, namely to reduce the required power of the light sources, increase the eye safety, and have the most dynamic possible selectable resolution with reduced amount of data and simplified detection, concepts of so-called line flash LIDAR and compressed sensing LIDAR using light structuring of the primary light emitted into a field of view have been connected to one another.

### SUMMARY

An operating method according to the present invention for a LIDAR system, in particular of the compressed sensing type, may have the advantage that due to the use of a fixedly predefined configuration for the light structuring, a light modulation to be complexly activated using a correspondingly complex light modulator may be omitted. This is achieved according an example embodiment of the present invention in that an operating method for a LIDAR system, in particular of the compressed sensing type, is provided, in which
(i) on the emitter side and in particular in an emitter unit, by structuring or light structuring of unstructured primary light, a predefined fixed and temporally constant matrix-like primary light pattern is generated from predefined and temporally constant primary column patterns and emitted as structured primary light in a line direction of the underlying matrix of the primary light pattern pivoting into a field of view for its scanning illumination and
(ii) on the receiver side and in particular in a receiver unit, a particular received column pattern, which may be understood as a secondary column pattern, is, for detection, on an assigned shared detector element of a detector arrangement received, mapped, and detected in total as secondary light from the field of view.

Preferred refinements of the present invention are disclosed herein.

In one preferred specific example embodiment of the method according to the present invention, various primary column patterns are provided, generated, and/or used in pairs as the basis for the matrix-like primary light pattern.

In particular, a unique assignment to the piece of depth information in the field of view for individually used detector elements is determined from the successive illumination using—in particular all—primary column patterns.

In an alternative or additional exemplary embodiment of the present invention, a time-of-flight histogram of the received light intensity is ascertained for each pixel in a primary column pattern and the depth information for the primary column pattern is determined therefrom.

For the reconstruction of the piece of depth information, it is particularly advantageous if the plurality of predefined primary column patterns used for the light structuring includes or forms a complete set of primary column patterns and in particular a complete orthogonal basis.

It is often also advantageous and sufficient, however, if alternatively thereto the plurality of predefined primary column patterns used for the light structuring only includes or forms a part of a complete set of primary column patterns and in particular only a part of a complete orthogonal basis, in particular in a proportion of approximately 25%. The expenditure in the formation and provision of the primary column patterns is reduced by this measure, without noteworthy restrictions occurring in the reconstruction of the depth information.

According to another alternative and advantageous refinement of the method according to the present invention, the plurality of predefined primary column patterns used for the light structuring includes a uniform or a differing resolution along the column direction.

Furthermore, the present invention relates to a control unit for a LIDAR system, which is configured, in an underlying LIDAR system, to initiate, carry out, run, regulate, and/or control a specific embodiment of the operating method according to the present invention.

Furthermore, the present invention also relates to a LIDAR system as such, which is designed including an emitter unit for generating and emitting primary light into a field of view for its illumination and including a receiver unit for receiving, detecting, and evaluating secondary light from the field of view.

The provided LIDAR system is configured to be used with a method according to the present invention and/or to be controlled or regulated by such a method.

The LIDAR system is advantageously designed for this purpose including a control unit designed according to the present invention, which is in turn configured to control the operation of the emitter unit and/or the receiver unit and in particular is configured to generate/emit and/or detect and assess emitted primary light and received secondary light according to the compressed sensing method.

In one advantageous specific embodiment of the LIDAR system according to an example embodiment of the present invention, the emitter unit includes as a light source unit a laser unit for generating and outputting unstructured primary light including an optical pattern generator optically coupled thereon, which is configured to record and structure the non-structured primary light according to the matrix-like primary light pattern and to output structured primary light as primary light including the matrix-like primary light pattern into the field of view.

In another preferred specific embodiment of the present invention, the optical pattern generator is designed as a mechanically fixedly predefined light mask including a design materially in accordance with or corresponding to the matrix-like primary light pattern.

The present invention also relates to a working device as such, which is designed including a LIDAR system designed according to the present invention and in particular as a vehicle.

### BRIEF DESCRIPTION OF THE DRAWINGS

Specific example embodiments of the present invention are described in detail with reference to the figures.

FIGS. 1 and 2 show schematic representations of specific example embodiments of LIDAR systems designed according to the present invention, which may be used in conjunction with the operating method according to the present invention.

FIG. 3 explains schematic aspects of one specific embodiment of the operating method according to the present invention on the basis of a plurality of rasterizing steps for a 4-pixel line-scanning process, as may be used according to the present invention.

FIG. 4 schematically illustrates the structure of a complete basis for a 4-pixel line-scanning process as may be used according to an example embodiment of the present invention.

FIGS. 5 and 6 schematically show, on the basis of a top view and a side view, aspects of another specific example embodiment of the LIDAR system according to the present invention.

FIG. 7 schematically shows further aspects of the present invention with focus on the reconstruction of the complete piece of information from the field of view.

### DETAILED DESCRIPTION OF EXAMPLE EMBODIMENTS

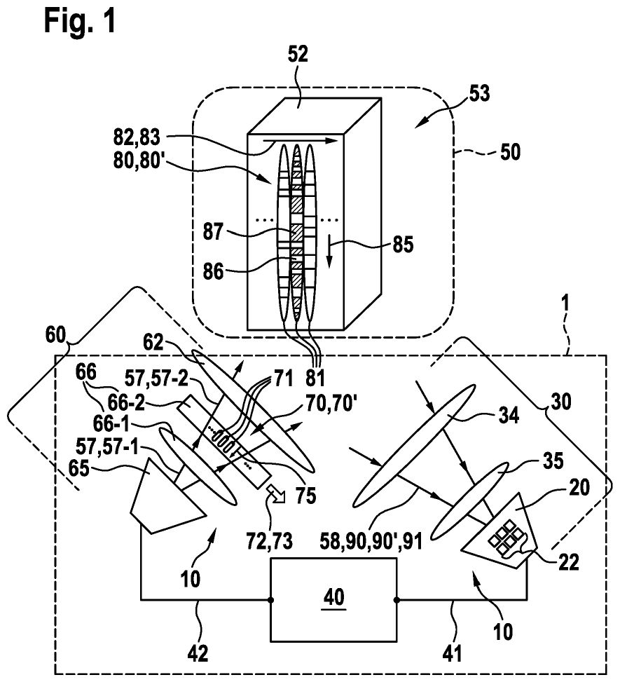

Exemplary embodiments of the present invention and the technical background are described in detail hereinafter with reference to FIGS. 1 through 7. Identical and equivalent and identically or equivalently acting elements and components are identified by the same reference numerals. The detailed description of the identified elements and components is not reproduced each time they occur.

The illustrated features and further properties may be isolated from one another in arbitrary form and combined with one another as desired without departing from the main features of the present invention.

For LIDAR systems 1, there are, among other things, two fundamental conceptual approaches, (i) on the one hand, namely so-called flash systems, in which entire scene 53 of field of view 50 is illuminated using primary light 57 and subsequently a parallel detection takes place, and (ii) on the other hand, so-called scanner systems, in which scene 53 is scanned, sampled, or rasterized by a single laser beam of primary light 57.

In addition to mixed forms such as vertical flash LIDAR, above all sampling or scanner systems have heretofore become widespread on the market, in particular due to high technological hurdles in the development of flash systems. Regular or conventional flash systems operate using two-dimensional detectors, which record a complete image of scene 53 in field of view 50 coded by time-of-flight.

An alternative concept for detection is the so-called compressed sensing LIDAR approach, which is also referred to as the photon-counting LIDAR approach, is based on a data compression at the level of the measured values, and is described, for example, in sources [1] through [3].

Flash systems require a high optical power to implement a broad reach, since the emitted optical power is distributed over a large spatial area. In contrast, purely scanning systems using point illumination often have problems with respect to the achievable resolution, the implementation of the scanning function, and the eye safety.

To avoid the disadvantages of both variants, the so-called vertical flash LIDAR was developed as a hybrid concept. A vertical line is emitted by the LIDAR sensor and thus a flash approach is followed in the vertical direction and a scanning approach is followed in the horizontal direction. As is typical in flash approaches, however, a planar, location-resolved detector is used here at least in one spatial direction. This type of detector is, on the one hand, very technically demanding, above all in the case of a high number of elements, thus pixels, and, on the other hand, cost intensive. In addition, a mapping optical system of very high quality and thermal stability is necessary to map the backscattered photons adequately on this sensor.

The approach provided according to the present invention is based on the compressed sensing principle and remedies these disadvantages.

FIGS. 1 and 2 show schematic representations of specific embodiments of LIDAR systems 1 designed according to the present invention, which may be used in conjunction with the operating method according to the present invention.

LIDAR system 1 includes an emitter unit 60, which may also be understood as an emitter optical system, and a receiver unit 30, which may also be understood as a receiver optical system.

A control unit 40 is advantageously formed, to which emitter unit 60 and receiver unit 30 are operatively connected via detection and control lines 41 and 42.

Emitter unit 60 includes a light source unit 65 for generating and emitting unstructured primary light 57, 57-1, a beamforming optical system 66 for beamforming and in particular for light structuring of unstructured primary light 57-1 to form structured primary light 57-2, and a deflection optical system 62 for the actual emission of structured primary light 57-2 into field of view 50 including scene 53, which may contain an object 52, for example.

Receiver unit 30 includes a primary optical system 34, for example, such as an objective, and optionally a secondary optical system 35, for example, such as a receiver-side collimator. Primary optical system 34 and secondary optical system 35 of receiver unit 30 are used to image secondary light 58 received from field of view 50 on a detector arrangement 20 including a plurality of sensor elements 22 or detector elements.

Via the detection of secondary light 58 from field of view 50, in cooperation with detector arrangement 20 and control and evaluation unit 40, field of view 50 of LIDAR system 1 may be detected and evaluated, in particular in the manner of the compressed sensing method.

During operation of LIDAR system 1, according to the present invention, on the emitter side for structuring of unstructured primary light 57, 57-1, a predefined fixed and temporally constant matrix-like primary light pattern 70, 80 is generated from predefined and temporally constant primary column patterns 71, 81 and in a line direction 72, 82 of an underlying matrix 70′, 80′ of light patterns 70, 80 is emitted in a pivoting and thus scanning or rasterizing manner into a field of view 50 for its scanning illumination as structured primary light 57, 57-2.

Furthermore, according to the present invention, on the receiver side during the detection and evaluation, secondary light 58 from field of view 50 as a particular secondary column pattern 91 is, on an assigned shared detector element 22 of a detector arrangement 20 received, mapped and detected in total as secondary light 58 from field of view 50

The structuring of unstructured primary light 57, 57-1 takes place in emitter unit 60 in beamforming optical system 66 after passing through a collimator 66-1 using a pattern generator 66-2, which may also be understood as a pattern element and is used, for example, by spatial concealment or exposure, to structure spatially the field of light passing through pattern generator 66-2 of beamforming optical system 66 perpendicularly to the propagation direction of the light, to thus form structured primary light 57, 57-2 and provide it to deflection optical system 62.

For this purpose, pattern generator 66-2 includes a predefined, fixed, and temporally constant configuration like a matrix 70′ to form a primary matrix-like light pattern 70, 80 including column patterns 71, 81, which are arrayed adjacent to one another in a line direction 72, 82, thus an extension direction of lines in underlying matrix 70′, 80′.

Accordingly, the construction of primary matrix-like light pattern 70 including corresponding light areas 76, 86 or pixels and dark areas 77, 87 or pixels takes place via the structure of matrix 70′.

By way of the mapping with the aid of deflection optical system 62 and a pivot movement 73, in particular corresponding to line direction 72, primary matrix-like light pattern 70 is projected with a corresponding pivot movement 83 into field of view 50, so that primary mapped matrix-like light pattern 80 appearing there including a matrix 80′ corresponds to underlying matrix 70′ and primary matrix-like light pattern 70 and in particular to the structure or configuration of pattern generator 66-2.

Emitter-side pivot movement 73 induces a scan of primary mapped matrix-like light pattern 80 using a corresponding pivot movement 83 over field of view 50.

According to the present invention, a photodetector which is simpler in comparison may be used in conjunction with detector arrangement 20, in particular including a smaller number of individual detector elements 22, which may also be referred to as pixels.

In addition, the particular mapping optical system may be reduced in the present invention to a less expensive lens system.

Furthermore, it is possible to compress the recorded data directly during the measuring process—therefore the name compressed sensing—by which, among other things, the data rate between light sensor 20 and processing logic 40 may be drastically reduced, for example, for the communication between a rotor and a stator of LIDAR system 1.

According to the present invention, a disadvantage of previous compressed sensing systems is also avoided, namely the requirement for a light modulator and its activation, for example, in terms of a spatial light modulator, which enables the shortest possible switching times.

This is achieved according to the present invention, as already described above, in that for the structuring of unstructured primary light 57, 57-1, a pattern generator 66-2 including a predefined, fixed, and temporally constant configuration like a matrix 70′ is used to form a primary matrix-like light pattern 70 including column patterns 71.

According to the present invention, the necessity of the variability of the structuring element and activation mechanisms required for this purpose is thus in particular dispensed with.

Required modulators have so far been hardly affordable and/or have severe restrictions in the usability.

For example, the fastest available modulators typically have a maximum switching frequency of 32 kHz, by which the possible image repetition rate is severely restricted. In addition, such components are often expensive and do not conform to the requirements in the automotive field.

One core feature of the present invention is thus that a compressed sensing approach is provided which manages without a light modulator in the conventional meaning, thus, for example, without a spatial light modulator.

A constant light pattern 70 is provided at the emitter sider and moved with the aid of an emitter-side scanning movement 73 over scene 53 in field of view 50, for example, in the horizontal direction. Primary matrix-like light pattern 70 appears as primary mapped matrix-like light pattern 80 in field of view 50 and scans over field of view 50 and scene 53.

Individual columns 71, 81 of primary pattern 70, 80 are each mapped according to the present invention—in particular in receiver unit 30—on a shared detector pixel 22 of detector arrangement 20.

The successive illumination of the columns using sufficiently many patterns or column patterns 71, 81 in turn enables a unique assignment of the piece of depth information to the individual pixels.

The core of a compressed sensing system or CS system 1 is made up of three components, namely a pulsed or modulated light source 65, an element 66-2 for structuring primary light 57, and a one-dimensional or 1D detector 20.

Conventionally, so-called digital light modulators or DLMs are used for the structuring of light 57. Alternatively, this component may conventionally also be implemented as an LCD display, due to which, however, the transmission and/or signal yield are reduced.

One core feature of the present invention is to replace the conventionally used mechanisms for dynamic pattern generation, namely in particular with a static pattern generator 66-2, which is configured according to the present invention, for the structuring of unstructured primary light 57, 57-1, to provide a predefined, fixed, and temporally constant configuration like a matrix 70′ to form a primary matrix-like light pattern 70 including column patterns 71. According to the present invention, the necessity of the variability of the structuring element and activation mechanisms required for this purpose is thus in particular dispensed with.

A binary pattern, thus “light” and “no light,” may be applied to the light beam by the structuring of the light field in the area of primary light 57. In a typical variant for CS system according to the present invention, this DLM is conventionally introduced after light source 65 into the optical path and therefore as a result scene 53 of field of view 50 is illuminated in a structured manner, as shown in conjunction with FIGS. 1 and 2.

Subsequently, the backscattered light may be received as secondary light 58 using a converging lens or in general using a primary optical system 34 in receiver unit 30 and measured on a one-dimensional or 1D photodetector of detector arrangement 20. If an underlying pattern is made up of a number of N columns, a number of N detectors may also be used for detection, which are arranged in one line, for example.

The detector elements or photodetectors may be, for example, cost-effective avalanche photodiodes (APD), which permit a high sensitivity with fast measurement time at the same time. The photodiode used records a complete histogram of the received photons as detector element 22 of detector arrangement 20.

To be able to reconstruct scene 53 in field of view 50 therefrom, scene 53 has to be illuminated using a complete set of structurings in terms of column patterns 71, 81.

Completely means in terms of a complete orthogonal basis, for example, on the basis of so-called Hadamard matrices.

To make the features and the further advantages of the process according to the present invention more transparent, initially a linear scanning of 4 pixels will be explained, for example, in terms of a general vertical flash LIDAR, as may be inferred in principle from FIGS. 1 and 2.

However, the present invention is in no way restricted to this specific embodiment and the description is used solely for better clarity of the general principle.

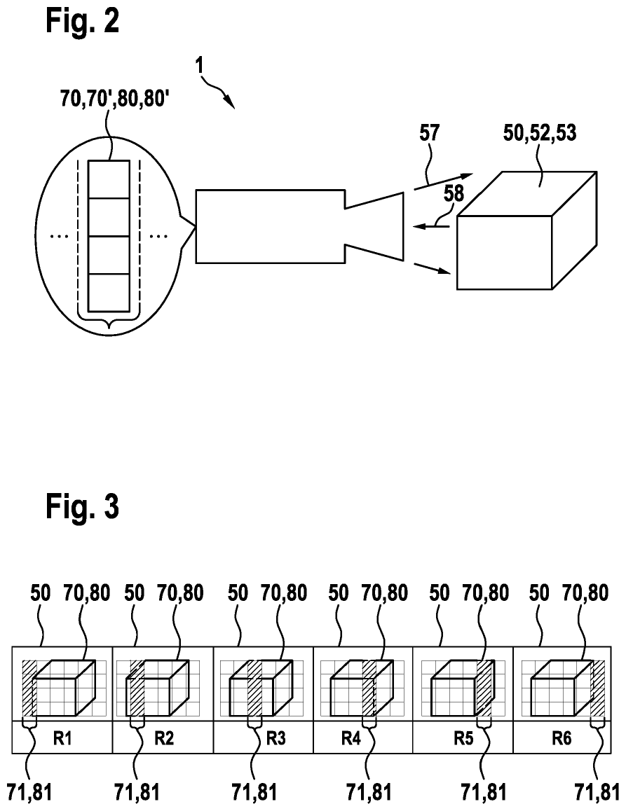

For each pixel 86, 87 of a column 71, 81, a time-of-flight histogram is recorded and the corresponding piece of depth information of column 71, 81 is generated therefrom. To obtain a complete point cloud for scene 53 of field of view 50, scene 53 has to be completely scanned, as is shown in conjunction with FIG. 3.

For this purpose, FIG. 3 schematically explains aspects of one specific embodiment of the operating method according to the present invention on the basis of a plurality of rasterizing steps R1 through R6 for a 4-pixel line-scanning process, as may be used according to the present invention.

For each rasterizing step R1 through R6, a different part of scene 53 of field of view 50 is illuminated and correspondingly detected via the detection of secondary light 58 in receiver unit 30.

The fundamental process is expanded according to the present invention by using a fixed and temporally constant pattern generator 66-2, on the one hand, and using the principle of compressed sensing.

To detect the required point cloud with the aid of the compressed sensing concept, for each column 71, 81 to be detected and thus each rasterizing step R1 through R6 of FIG. 3, a complete set of patterns in terms of column patterns 71, 81 has to be illuminated and detected.

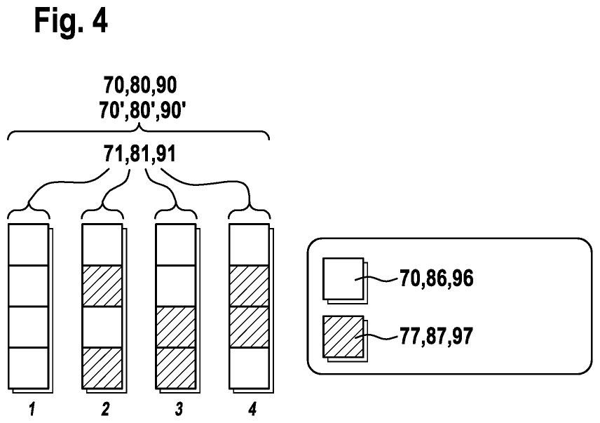

Such a set of patterns 71, 81 is shown in FIG. 4 for the 4-pixel example set forth in FIG. 3.

FIG. 4 thus schematically illustrates for this purpose the structure of a complete basis for a 4-pixel line-scanning process, as may be used according to the present invention.

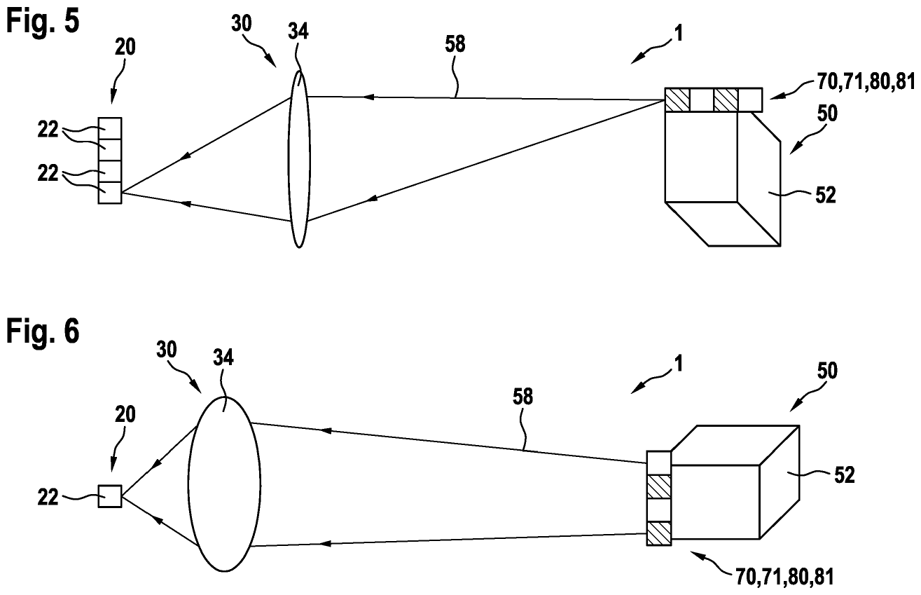

A unit is provided as detector unit 20, which in the mentioned example maps vertically on a single detector and horizontally on one of multiple pixels 22, as is described in conjunction with FIGS. 5 and 6.

FIGS. 5 and 6 schematically explain for this purpose, on the basis of a top view and a side view, aspects of another specific embodiment of underlying LIDAR system 1 according to the present invention.

In this case, detector pixels or detector elements 22 of detector arrangement 20 are situated pivoted, for example, by 90° in relation to the present related art, as compared to a conventional vertical flash LIDAR system.

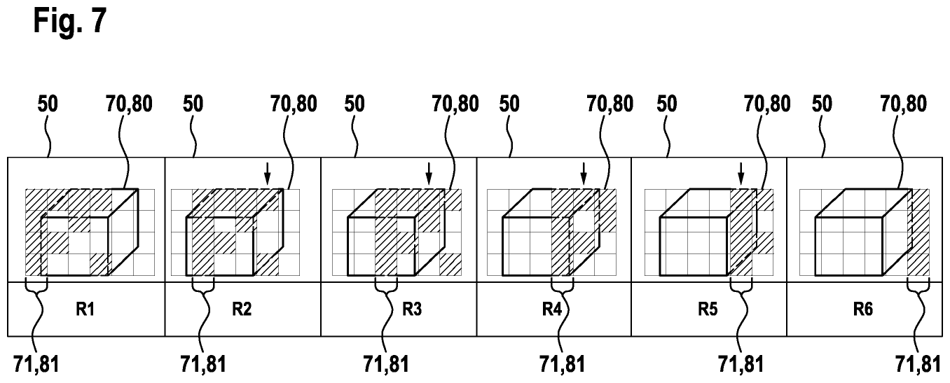

Using this type of detector arrangement 20, a flowing pattern may be projected as matrix pattern 70, 80 over scene 53 in field of view 50. Such a scanning process with the aid of pivot movement 73, 83 in line direction 72, 82 of underlying pattern 70, 80 is shown in conjunction with FIG. 7.

FIG. 7 schematically explains for this purpose further aspects of the present invention with focus on the reconstruction of the complete piece of information from field of view 50.

The various line patterns—here in terms of column patterns 71, 81, for example from FIG. 4—are projected directly next to one another in scene 53 and spatially displaced constantly from a preceding rasterizing step Rj to a following rasterizing step Rj+1.

In detector arrangement 20, in this example all 4 pixels of a particular column pattern 71, 81 are detected in total in a detector element 22. If constant pattern 71, 81 is moved by a total of 4 steps to the right, namely offset temporally via a scanning movement 73, 83, a particular point in scene 53 has been consecutively illuminated using all required patterns in terms of column patterns 71, 81 and the signal may be reconstructed in this case by 100% from the measured data.

This circumstance is illustrated by the arrow in FIG. 7 for rasterizing steps R2 through R5.

In principle, the point cloud for each column may be reconstructed with the aid of this structure.

With respect to the number of the detector pixels—interpreted as detector elements 22 of detector arrangement 20—initially no advantage thus results compared to a conventional detector. However, the approach according to the present invention may be implemented using a significantly simpler converging optical system (for example, without complex mapping of the optical system) and additionally enables a greater (settable) pixel distance in detector arrangement 20 in the detector (relevant for, for example, FMCW-based LIDAR systems).

In addition, a further core aspect of the compressed sensing approach according to the present invention is not to use a complete pattern set, but rather to skillfully reduce the set of column patterns 71, 81 used.

Very good image results may already be generated here using approximately 25% of the actually required patterns in terms of column patterns 71, 81.

The virtual resolution of a detector line including N pixels may thus be increased by the factor of 4 to 4N, with a corresponding reduction of the amount of data to be transferred.

Illumination structured in this way may be generated relatively easily via a structured laser array, for example, in terms of surface emitters, VCSEL elements, or stacked edge emitters, as light sources in combination with a mapping optical system.

The principle is not restricted to one line, but rather may also be implemented as a structured light spot similar to a micromirror scanner, in which the scanning steps may accordingly be significantly enlarged.

The present invention may be implemented both on the emitting side and on the receiving side. If the proposed structure is implemented in receiving optical system 30 instead of emitting optical system 60, in addition a flatter illumination is required of emitting optical system 60. This generally represents significantly reduced requirements for the optical system to be used, since only a more extended beam of primary light 57 has to be generated. The latter also increases the maximum permissible power in terms of the eye safety and thus enables broader reaches.

Among other things, the following further advantages result with the present invention:
The principle is completely compatible with all routine scanning principles, e.g., micromirror scanners, macroscanner (rotating system or rotating mirror), polygonal mirror, etc.
The scanning movement may take place horizontally, vertically, and in combined form.
The principle is suitable for both Direct-Time-of-Flight or dToF systems and also for FMCW systems.
Due to the present invention, poorly available and sometimes slow spatial light modulators become obsolete and the use of compressed sensing approaches in the automotive field in LIDAR systems is thus enabled.
It is a purely static structure. The pattern illumination takes place solely due to the already provided scanning movement.
The amounts of data which have to be transferred from rotor to stator or from LIDAR system 1 to a main system (for example, automobile) are significantly reduced by the compressed sensing approach, because the data are already compressed during the measuring process, similarly to JPEG compression in photo cameras.

### SOURCES

[1] Howland et al., “Photon-counting compressive sensing laser radar for 3D imaging,” in: Applied Optics 50 (31), November 2011.

[2] Howland et al., “Photon counting compressive depth mapping,” in: Optics Express 21 (20), September 2013.

[3] Edgar et al., “Real-time computational photon-counting LIDAR,” in: Optical Engineering 57 (3), March 2018.

1-10. (canceled)

11. An operating method for a compressed sensing type LIDAR system, comprising:
(i) on an emitter side of the LIDAR system, generating a predefined fixed and temporally constant matrix-like primary light pattern by structuring unstructured primary light using predefined and temporally constant primary column patterns, and emitting the predefined primary light pattern as structured primary light in a line direction of an underlying matrix of the predefined primary light pattern by pivoting into a field of view for a scanning illumination; and
(ii) on a receiver side of the LIDAR system, on an assigned shared detector element of a detector arrangement, receiving, mapping, and detecting in total as secondary light from the field of view, a particular received column pattern for detection as a secondary column pattern.

12. The operating method as recited in claim 11, wherein:
a plurality of primary column patterns are provided, generated, and/or used in pairs as a foundation for the matrix-like primary light pattern; and
from successive illumination using the plurality of primary column patterns, a unique assignment for depth information in the field of view to individual objects and/or elements of a scene in the field of view is determined.

13. The operating method as recited in claim 11, wherein for each pixel in the primary and/or secondary column pattern, a time-of-flight histogram of received light intensity is ascertained and a piece of depth information for the primary and/or secondary column pattern is determined from time-of-flight histogram.

14. The operating method as recited in claim 11, wherein the predefined primary column patterns used for the structuring of the unstructured primary light includes or forms a complete set of primary column patterns or a complete orthogonal basis or a part of a complete orthogonal basis in a proportion of approximately 25%.

15. The operating method as recited in claim 11, wherein the predefined primary column patterns used for the structuring of the unstructured primary light have a uniform or differing resolution along a column direction.

16. A control unit for operating a compressed sensing type LIDAR system, the control unit configured to control the LIDAR system to:
(i) on an emitter side of the LIDAR system, generate a predefined fixed and temporally constant matrix-like primary light pattern by structuring unstructured primary light using predefined and temporally constant primary column patterns, and emitting the predefined fixed and temporally constant matrix-like primary light pattern as structured primary light in a line direction of an underlying matrix of the light pattern by pivoting into a field of view for a scanning illumination; and
(ii) on a receiver side of the LIDAR system, on an assigned shared detector element of a detector arrangement, receive, map, and detect in total as secondary light from the field of view, a particular received column pattern for detection as a secondary column pattern.

17. A LIDAR system, comprising:
an emitter unit configured to generate and emit primary light into a field of view for illumination of the field of view; and
a receiver unit configured to receive, detect, and evaluate secondary light from the field of view; and
a control unit configured to control the LIDAR system to:
(i) on an emitter side of the LIDAR system, generate, using the emitter unit, a predefined fixed and temporally constant matrix-like primary light pattern by structuring unstructured primary light using predefined and temporally constant primary column patterns, and emitting the predefined fixed and temporally constant matrix-like primary light pattern as structured primary light in a line direction of an underlying matrix of the light pattern by pivoting into a field of view for a scanning illumination, and
(ii) on a receiver side of the LIDAR system using the receiver unit, on an assigned shared detector element of a detector arrangement, receive, map, and detect in total as secondary light from the field of view, a particular received column pattern for detection as a secondary column pattern.

18. The LIDAR system as recited in claim 17, wherein the emitter unit includes, as a light source unit, a laser unit configured to generate and output the unstructured primary light including an optical pattern generator optically coupled thereon, which is configured to receive and structure the nonstructured primary light according to the matrix-like primary light pattern and to output structured primary light as the primary light including the matrix-like primary light pattern into the field of view.

19. The LIDAR system as recited in claim 18, wherein the optical pattern generator is a mechanically fixedly predefined light mask including a design corresponding to the matrix-like primary light pattern.

20. A vehicle, comprising:
a LIDAR system including:
an emitter unit configured to generate and emit primary light into a field of view for illumination of the field of view; and
a receiver unit configured to receive, detect, and evaluate secondary light from the field of view; and
a control unit configured to control the LIDAR system to:
(i) on an emitter side of the LIDAR system, generate, using the emitter unit, a predefined fixed and temporally constant matrix-like primary light pattern by structuring unstructured primary light using predefined and temporally constant primary column patterns, and emitting the predefined fixed and temporally constant matrix-like primary light pattern as structured primary light in a line direction of an underlying matrix of the light pattern by pivoting into a field of view for a scanning illumination, and
(ii) on a receiver side of the LIDAR system using the receiver unit, on an assigned shared detector element of a detector arrangement, receive, map, and detect in total as secondary light from the field of view, a particular received column pattern for detection as a secondary column pattern.
